(19) United States
(12) Patent Application Publication
(10) Pub. No.: US 2008/0307939 A1
(43) Pub. Date: Dec. 18, 2008

(54) METHODS AND SYSTEMS TO DRIVE ROTARY PRESSES

(76) Inventor: Gregory S. Smith, McPherson, KS (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/139,113

(22) Filed: Jun. 13, 2008

Related U.S. Application Data
(60) Provisional application No. 60/944,330, filed on Jun. 15, 2007.

(51) Int. Cl. B26D 1/56; B30B 3/04; B30B 15/08; B23D 25/02

(52) U.S. Cl. 83/331; 100/172; 100/176; 100/39; 83/37

(57) ABSTRACT

Methods and systems to drive rotary presses are described. In one described example, a rotary press system includes a first rotary press and a second rotary press adjacent to the first rotary press. The first and the second rotary presses are to receive a strip of material. A drive member is operatively coupled to the first and the second rotary presses and a motor coupled to the drive member rotates the drive member to cause the first and second rotary presses to process the strip material.

### RELATED APPLICATIONS

This patent claims the benefit of U.S. Provisional Application Ser. No. 60/944,330, filed on Jun. 15, 2007, which is incorporated herein by reference in its entirety.

### FIELD OF THE DISCLOSURE

The present disclosure relates generally to rotary presses, and more particularly, to methods and systems to drive rotary presses.

### BACKGROUND

Rotary presses are often used in connection with mass production or manufacturing systems to cut (e.g., pre-notch, punch, shear, etc.) material such as, for example, sheet material, strip material, continuous web material, etc. For example, rotary presses can be used in connection with roll-forming systems, which move a strip material through successive pairs of rollers that progressively bend and form the strip material to a desired shape and cross-section. A rotary press can be used to perform a series of operations prior to roll-forming the strip material to facilitate producing a desired product. Such operations may include cutting, pre-notching, punching and/or shearing the strip material. Unlike a standard material press, which requires material to be stationary when shearing or punching the material, a rotary press can cut non-stationary material, thereby, eliminating the need to stop the material each time a cutting operation is performed. This allows the material to maintain a relatively continuous forward movement through a post process such as a roll-forming process.

A traditional rotary press is driven by a respective drive member such as, for example, a motor. The motor causes opposing upper and lower press rams to move along substantially circular paths in opposing directions so that the upper and lower rams come together at a cutting point (e.g., a shearing point, a punching point, a nip point, etc.). When the upper and lower rams meet at the cutting point, the rams are moving in the direction of the material flow to enable cutting the material as it moves.

### BRIEF DESCRIPTION OF THE DRAWINGS

FIG. 1 is a side view of an example production system configured to process a moving material using an example rotary press system.

FIG. 2A is an elevated view and FIG. 2B is an isometric view of the example rotary press system of FIG. 1.

FIG. 3 is a time sequence view depicting the operation of the example rotary press system of FIGS. 1, 2A and 2B.

FIG. 4 is an example material forming process that may be configured to use the example rotary press system of FIGS. 1, 2A and 2B.

FIGS. 5A and 5B are isometric views of example products that may be produced by the example material forming process of FIG. 4.

FIG. 6 is a flow chart diagram of an example method that may be used to control the example rotary press system of FIGS. 1, 2A, 2B, 3 and 4.

FIG. 7 is a block diagram of an example processor system that may be used to implement the example methods and systems described herein.

FIG. 8 illustrates another example rotary press system described herein.

FIG. 9 is a time sequence view depicting the operation of the example rotary press system of FIG. 8.

FIG. 10 is a flow chart diagram of an example method that may be used to control the example rotary press system of FIG. 8.

FIG. 11 illustrates an example product that may be produced by the example rotary press system of FIG. 8.

### DETAILED DESCRIPTION

In general, the example methods and systems described herein drive a rotary press system to process a strip material. In particular, the rotary press system includes a first rotary press operatively coupled to a second rotary press that are driven via a common drive member that causes the first and the second rotary presses to process the strip material. Each of the first and the second rotary presses may include different cutting tools such as, for example, a punching tool, a shearing tool, and/or any combination thereof, etc. Alternatively, the first and the second rotary presses may include a cutting tool such as, for example, a die platen, to produce large patterns, multiple patterns, different patterns, etc., when processing the strip material. The example rotary press systems can be configured via, for example, a controller, a processor, etc., to provide synchronized operation between the first and the second rotary presses thereby requiring less down time or maintenance time to adjust, balance and/or synchronize the example rotary press systems. Thus, when the example rotary press systems described herein are coupled to subsequent processes such as roll-forming processes, the example rotary press systems increase the overall output of the material forming process.

Additionally, providing the rotary press system with a common drive motor substantially reduces the overall foot print (e.g., floor space area) that would otherwise be required if a first rotary press and a second rotary press were provided with respective drive motors and respective sets of drive gears. Decreasing the foot print or the required floor space area can increase production by increasing the number of production lines that can be installed in a particular area.

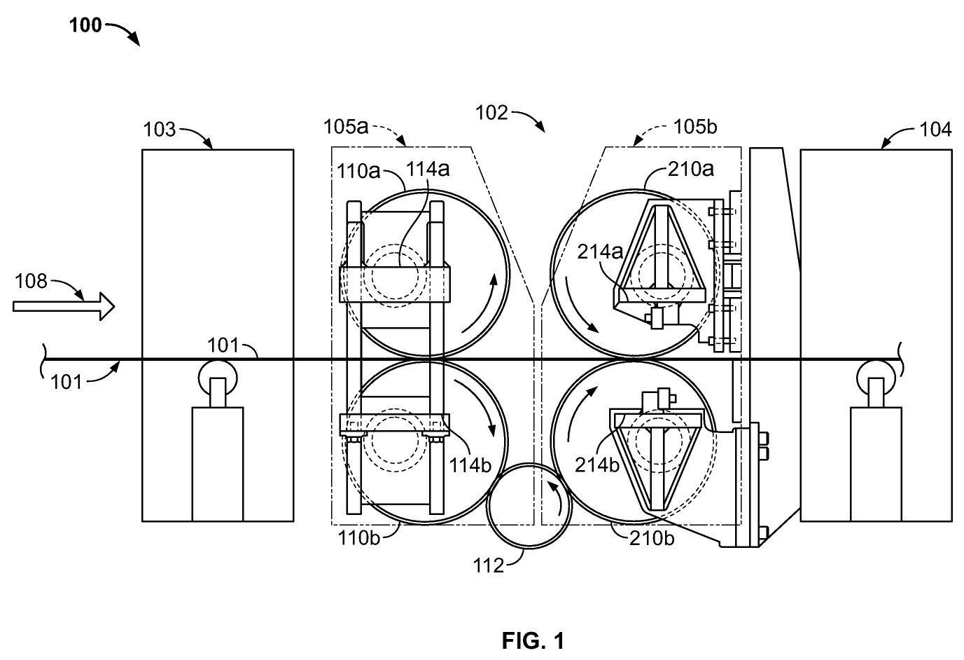

FIG. 1 is a side view of an example production system 100 configured to process a moving material 101 using an example rotary press system 102. In some example implementations, the example production system 100 may be part of a continuously moving material manufacturing system, which may include a plurality of subsystems that modify or alter the material 101 using processes that, for example, punch, shear, and/or fold the material 101. The material 101 may be a metallic strip material supplied on a roll or may be any other metallic or non-metallic material.

In the illustrated example, the example rotary press system 102 may be disposed between a first operating unit 103 and a second operating unit 104. The material 101 travels through the first operating unit 103, the rotary press system 102, and the second operating unit 104 in a direction generally indicated by arrow 108. The first operating unit 103 may be a continuous material delivery system that transports the material 101 to the rotary press system 102. Additionally, the first and second operating units 103 and 104 may be any desired type of process associated with a continuously moving material manufacturing system or the like.

As shown, the rotary press system 102 includes a first rotary press 105a and a second rotary press 105b. Each of the rotary presses 105a and 105b is configured to perform one or more material altering processes (e.g., cutting processes) on the material 101 as it moves through the example production system 100. For example, the rotary presses 105a and 105b may be configured to shear, punch, and/or otherwise cut or penetrate the material 101. In some example implementations, the rotary press system 102 may use conventional cutting tools such as those used in standard material presses. In the illustrated example, the first rotary press 105a is configured to punch the material 101 and the second rotary press 105b is configured to shear the material 101 without stopping the material 101. However, in other example implementations, both of the rotary presses 105a and 105b may be configured to punch or shear the material 101, or the first rotary press 105a may be configured to shear and the second rotary press 105b may be configured to punch the material 101.

During operation, the first rotary press 105a receives the material 101 from the first operating unit 103 and shears, punches or otherwise cuts or penetrates the material 101. The second rotary press 105b receives the material 101 from the first rotary press 105a and shears, punches or otherwise cuts or penetrates the material 101. The second operating unit 104 may then receive the processed (e.g. cut) material from the second rotary press 105b. For example, after the first rotary press 105a and the second rotary press 105b have sheared, punched, or otherwise cut or penetrated the material 101, the material 101 may be taken away or moved away in a continuous manner from the second rotary press 105b by the second operating unit 104. Alternatively, the first operating unit 103 may be configured to drive or propel the processed material 101 through the first rotary press 105a and the second rotary press 105b and toward the second operating unit 104.

As described above, the rotary press system 102 may be used within a production system such as the example production system 100. Alternatively, the rotary press system 102 may be used as a standalone system. Additionally, the rotary presses 105a and 105b may be configured to shear, punch, or otherwise cut or penetrate any continuously moving material including, for example, steel, aluminum, other metallic materials, plastic, fiberglass, wire, cable, etc.

As shown by way of example in FIG. 1, the first rotary press 105a includes an upper spur gear 110a that is directly engaged to (e.g., meshes with) a lower spur gear 110b. An upper ram 114a and a lower ram 114b are rotatably coupled to the upper spur gear 110a and the lower spur gear 110b, respectively. The rams 114a and 114b may be mechanically coupled to material penetration or cutting devices such as, for example, conventional cutting tools (i.e., punch and die sets, cut-off blade and cut-off ram sets) or other types of cutting tools. Additionally, the rams 114a and 114b are configured to provide sufficient structural strength to maintain their structural integrity while impacting (e.g., cutting) the material 101 as it moves (e.g., continuously) through the rotary press 105a. The second rotary press 105b includes components 210a, 210b, 214a and 214b which are substantially similar or identical to respective ones of the components 110a, 110b, 114a, 114b of the first rotary press 105a.

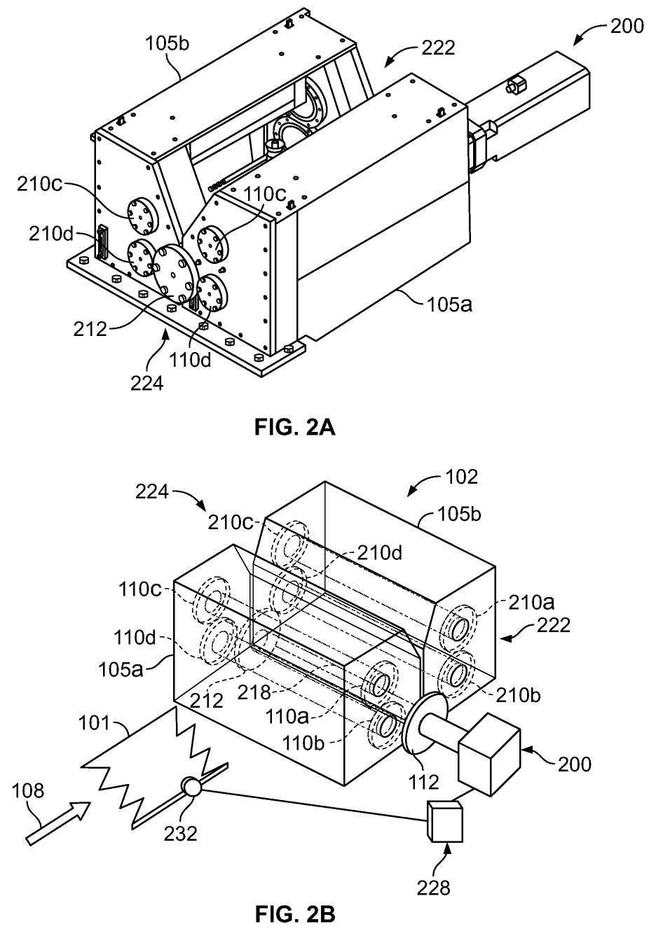

To drive the rotary presses 105a and 105b, the example rotary press system 102 is provided with a common drive gear 112. In the illustrated example, the common drive gear 112 is shown as being directly engaged to the lower spur gear 110b of the first rotary press 105a and the lower spur gear 210b of the second rotary press 105b. The upper spur gears 110a and 210a may directly engage respective ones of the lower spur gears 110b and 210b, and the lower spur gears 110b and 210b may directly engage the common drive gear 112 to form a direct drive configuration. In this configuration, the common drive gear 112 may directly drive the spur gears 110a, 210a, 110b and 210b to cause the spur gears 110a, 210a, 110b and 210b to rotate about their respective rotational axes to enable the rams 114a and 114b and the rams 214a and 214b to work cooperatively to shear, punch, or otherwise cut or penetrate the material 101 as it moves through the rotary press system 102. To rotate the common drive gear 112, the example rotary press system 102 is provided with a rotary actuation member, which in the illustrated example of FIGS. 2A and 2B is implemented using a drive motor 200.

In the illustrated example, the upper spur gears 110a and 210a may be configured to move the upper rams 114a and 214a along respective generally circular paths and the lower spur gears 110b and 210b are configured to move the lower rams 114b and 214b along respective generally circular paths. In particular, the upper spur gear 110a, the lower spur gear 110b, and the common drive gear 112 work cooperatively to move the upper ram 114a along an upper generally circular path and the lower ram 114b along a lower generally circular path in a direction (e.g., a clockwise direction) opposite the direction (e.g. a counter-clockwise direction) of the upper path. Similarly, the upper spur gear 210a, the lower spur gear 210b, and the common drive gear 112 work cooperatively to move the upper ram 214a along an upper generally circular path and the lower ram 214b along a lower generally circular path in a direction opposite the direction of the upper path. In some example implementations, the rams 114a, 114b, 214a and 214b can be configured to travel along respective generally elliptical paths by using cam-shaped rotary members to implement the gears 110a, 110b, 210a and 210b and a direct drive or an indirect drive configuration to drive the cam-shaped rotary members.

In the illustrated example of FIG. 1, the gear ratios between the drive gear 112 and the spur gears 110b and 210b cause the rams 114a and 114b and the rams 214a and 214b to travel along their respective 360-degree paths based on a particular number of 360-degree rotations of the motor 200 and the drive gear 200. However, in other example implementations, the gear ratios between drive member 112 and the spur gears 110b and 210b can be configured differently to cause the rams 114a, 114b, 214a and 214b to complete respective 360-degree cycles while the motor 200 and the drive gear 112 complete fewer or more 360-degree rotations.

Although not shown in FIG. 1, the other end sides of the rotary presses 105a and 105b include gears that are substantially similar or identical to respective ones of the gears 110a, 110b, 210a, 210b and 112. The gears 110a, 110b, 210a, 210b and 112, and their respective gears on the other end side of the example rotary press system 102 shown in FIG. 2B, may be implemented using any type of gears or other drive members having any shape and that enable rotation about a rotational axis.

FIG. 2A is an elevated view and FIG. 2B is an isometric view of the example rotary press system 102 of FIG. 1. FIG. 2B shows a first gear assembly side 222 described above in connection with FIG. 1 and a second gear assembly side 224 of the rotary press system 102. The sides 222 and 224 of the rotary press system 102 include substantially similar or identical components arranged or configured in substantially the same way. As shown, the first gear assembly side 222 includes the upper and lower spur gears 110a and 110b of the rotary press 105a, the upper and lower spur gears 210a and 210b of the rotary press 105b, and the common drive gear 112. The second gear assembly side 224 includes upper and lower spur gears 110c and 110d of the rotary press 105a, upper and lower spur gears 210c and 210d of the rotary press 105b, and a common drive gear 212 to drive the gears 110c, 110d, 210c and 210d.

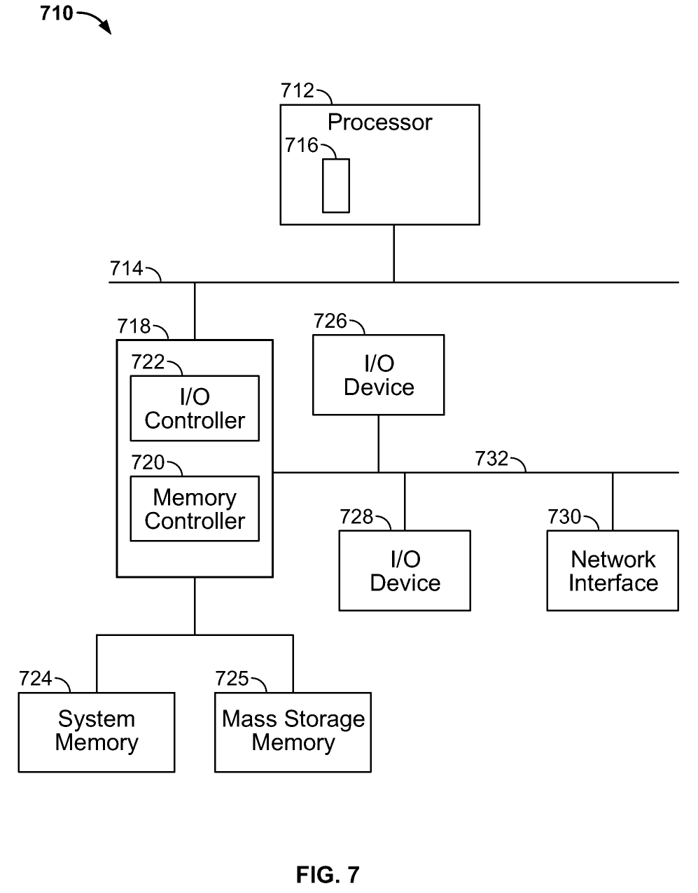

In the illustrated example, the common drive gear 112 is directly engaged to the lower spur gears 110b and 210b, and the common drive gear 212 is directly engaged to the lower spur gears 110d and 210d. The drive gear 212 is coupled to the drive gear 112 via a shaft 218 (e.g., a driveshaft), and an end of the shaft 218 is coupled to the drive motor 200. The motor 200 may be any suitable motor such as, for example, a stepper motor, a servo motor, a hydraulic motor, etc. To control the speed and acceleration of the motor 200 and, thus, the movement of the rams 114a, 114b, 214a and 214b of the rotary press system 102, the rotary press system 102 is provided with a controller 228, which can be implemented using the example processor system 710 of FIG. 7 discussed below. In addition, the rotary press system 102 is provided with an encoder 232 to monitor the speed and/or length of the material 101 passing through the rotary press system 102. The encoder 232 may be implemented using, for example, an optical encoder, a magnetic encoder, etc. In other example implementations, other sensor devices may be used instead of an encoder to monitor the speed and/or length of the material 101.

The motor 200 transmits torque via the shaft 218 to the drive gears 112 and 212. Driving the drive gears 112 and 212 via the shaft 218 allows delivering substantially equal or the same amount of torque to both ends of the upper and lower rams 114a, 114b, 214a and 214b of the presses 105a and 105b. In this manner, the substantially equal or same amount of force applied to each end of the rams 114a, 114b, 214a and 214b causes both ends thereof to advance through a generally circular or elliptical path substantially simultaneously with forces uniformly distributed across their length. Maintaining a uniform driving force across the rams substantially reduces or eliminates axial twisting or torsion along the length of the rams 114a, 114b, 214a and 214b, which in turn, substantially reduces or eliminates tool wear due to tool misalignments upon impact when axial twisting or torsion occurs. The uniform driving force also enables the presses 105a and 105b to cut relatively heavy gauge material by maintaining a substantially uniform or equal cutting force across an entire width of a strip material.

In the illustrated example of FIG. 2B, the common drive gears 112 and 212, the lower spur gears 110b, 110d, 210b and 210d, and the upper spur gears 110a, 110c, 210a and 210c form a direct-drive system. In the direct-drive system, the drive motor 200 directly drives (e.g., without any other interposing mechanism or device such as a transmission or the like) the shaft 218 and the common drive gears 112 and 212. In alternative example implementations, other drive configurations may be used. For example, various drive members may be coupled to each other using any combination of chains, belts, frictional engagement devices, fluid couplings, etc. Of course, one or more of the gears 110a, 210a, 110b, 210b, 110c, 210c, 110d, 210d, 112 and 212 may be replaced with pulleys, sprockets, or any other suitable drive members. In some example implementations, the drive motor 200 can be coupled directly to the drive gear 112 in a direct-drive configuration with or without an intervening gear box.

In the direct-drive system, the drive gear 112 directly drives the lower spur gears 110b and 210b to rotate about their rotational axes and the lower spur gears 110b and 210b then directly drive the upper spur gears 110a and 210a to rotate about their rotational axes in a counter-rotating direction relative to the lower spur gears 110b and 210b. The counter-rotation of the spur gears 110a and 110c relative to the spur gears 110b and 110d causes the rams 114a and 114b (shown in FIG. 1) to substantially match the translational direction of the material 101 as the material 101 moves through the rotary press 105a. Similarly, the counter-rotation of the spur gears 210a and 210c relative to the spur gears and 210b and 210d causes the rams 214a and 214b to substantially match the translational direction of the material 101 as the material 101 moves through the rotary press 105b. In addition, the controller 228 is configured to control the speed and acceleration of the motor 200 so that the rams 114a and 114b of the rotary press 105a and the rams 214a and 214b of the rotary press 105b match the translational speed of the material 101 as the rams 114a, 114b, 214a and 214b approach and travel through a cutting position (e.g., a nip position, a shearing position, a punching position, a pressing position, etc.) in the same direction as the direction traveled by the material 101. In this manner, the cutting tool members can shear, punch, or otherwise cut or penetrate the material 101 without interrupting the continuous movement of the material 101 as it travels through the rotary presses 105a and 105b.

Providing the rotary press system 102 of FIGS. 1, 2A and 2B with the common drive motor 200 and the common drive gears 112 and 212 to drive the rotary presses 105a and 105b substantially reduces the overall foot print (e.g., floor space area) that would otherwise be required if each of the rotary presses 105a and 105b were provided with respective drive motors and respective sets of drive gears. Decreasing the foot print or the required floor space area can increase production by increasing the number of production lines that can be installed in a particular area. Additionally, the rotary press system 102 can provide synchronized operation between the rotary presses 105a and 105b, thereby, requiring less down time or maintenance time to adjust, balance and/or synchronize the presses 105a and 105b as would otherwise be required by rotary presses having respective drive motors. Thus, when the rotary press system 102 is coupled to subsequent processes such as roll-forming processes, as discussed above, the rotary press system 102 can increase the overall output of the material forming process.

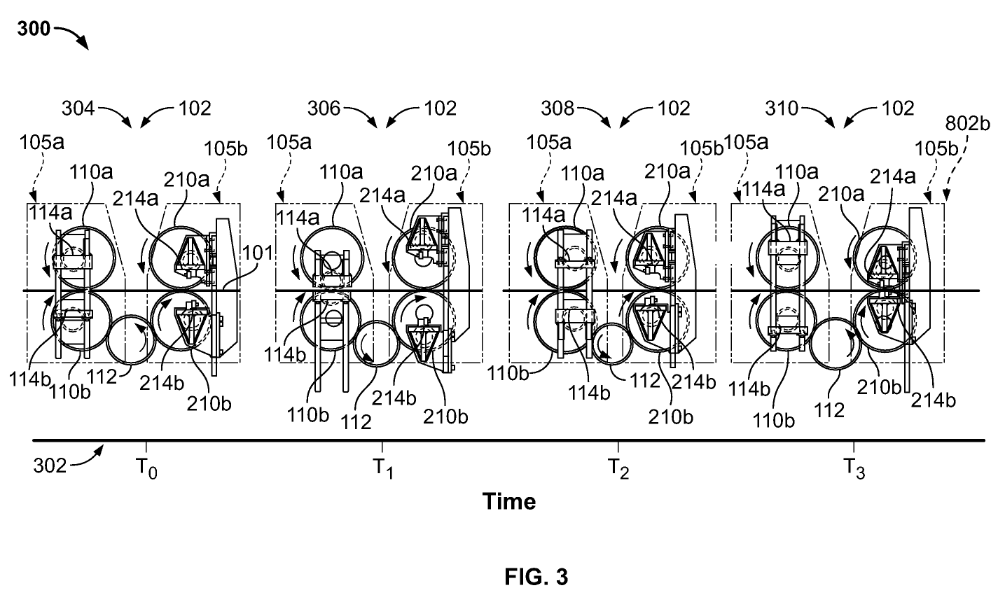

FIG. 3 is an example time sequence view 300 showing the operation of the example rotary press system 102 of FIGS. 1, 2A and 2B. In particular, the example time sequence 300 shows the time-varying relationship between the common drive gear 112, the spur gears 110a, 110b, 210a and 210b, and the rams 114a, 114b, 214a and 214b during operation of the rotary press system 102 of FIGS. 1, 2A and 2B. As shown in FIG. 3, the example time sequence 300 includes a time line 302 and shows the rotary presses 105a and 105b at several times during operation. More specifically, the rotary presses 105a and 105b are shown in a sequence of rotary press phase positions indicated by a T₀ phase position 304, a T₁ phase position 306, a T₂ phase position 308, and a T₃ phase position 310. As the upper spur gears 110a and 210a rotate in a clock-clockwise direction and the lower spur gears 110b and 210b rotate in a clockwise direction, the operation of the rotary presses 105a and 105b progresses through the phases 304, 306, 308 and 310. Although FIG. 3 depicts only the first gear assembly side 222 (FIG. 2B) of the rotary press system 102, both of the sides 222 and 224 of the rotary press system 102 shown in FIG. 2B work cooperatively to enable operation of the rotary presses 105a and 105b according to the example operational sequence shown in FIG. 3.

Now turning in detail to the operation of the rotary presses 105a and 105b, the drive motor 200 drives the common drive gear 112 in a counter-clockwise direction. The common drive gear 112, in turn, causes the lower spur gears 110b and 210b to rotate in a clockwise direction, and each of the gears 110b and 210b causes a respective one of the upper spur gears 110a and 210a to rotate in a counter-clockwise direction. As the spur gears 110a and 110b and 210a and 210b rotate, the rams 114a, 114b, 214a and 214b travel along their respective generally circular or elliptical paths as shown by the phase positions 304, 306, 308 and 310. Also, the rams 114a and 114b of the rotary press 105a are held in substantially vertical alignment relative to each other as they travel along their respective paths and the rams 214a and 214b of the rotary press 105b are similarly held in substantially vertical alignment relative to each other.

The T₀ phase position 304 shows the rams 114a and 114b of the rotary press 105a and the rams 214a and 214b of the rotary press 105b at their initial position. In the illustrated example of FIG. 3, the position of the rams 114a and 114b of the rotary press 105a are 180 degrees out of phase with the positions of the rams 214a and 214b of the rotary press 105b. The T₁ phase position 306 shows the rams 114a and 114b of the rotary press 105a as they travel through the cutting position (e.g., a pressing position, a nip position, a shearing position, a punching position, etc.). As shown in the T₁ phase position 306, when the rams 114a and 114b of the rotary press 105a are in the cutting position, the rams 214a and 214b of the rotary press 105b are in a maximum open position (e.g. the rams 214a and 214b are the furthest away from one another along their respective circular or elliptical paths). As the rams 114a and 114b meet to punch, cut, etc., the material 101 at the pressing position, the material 101 may be punched to remove a portion 301 as the material 101 moves through the rotary press 102.

The T₂ phase position 308 shows the rams 114a and 114b of the rotary press 105a as they travel away from the cutting position and shows the rams 214a and 214b of the rotary press 105b as they travel toward a cutting position. The T₃ phase position 310 shows the rams 214a and 214b of the rotary press 105b as they travel through the cutting position and shows the positions of the rams 114a and 114b of the rotary press 105a as they travel away from their cutting position. The illustrated example shows that when the rams 214a and 214b of the rotary press 105b are in the cutting position, the rams 114a and 114b of the rotary press 105a are in a maximum open position (e.g. the rams 114a and 114b are the furthest away from one another along their respective circular or elliptical paths).

Although the illustrated example of FIG. 3 shows that the rams 114a, 114b, 214a and 214b of the rotary presses 105a and 105b approach their respective cutting positions in alternating phases, in other example implementations, the rotary presses 105a and 105b may punch, shear, or otherwise cut or penetrate the material 101 in the same phase (e.g., at substantially the same time). In addition, the rams 114a and 114b of the rotary press 105a and the rams 214a and 214b of the rotary press 105b are not limited to being 180 degrees out of phase. Instead, in alternative example implementations, the rotary presses 105a and 105b can be out of phase relative to one another by any other amount including, for example, 45 degrees, 90 degrees, etc.

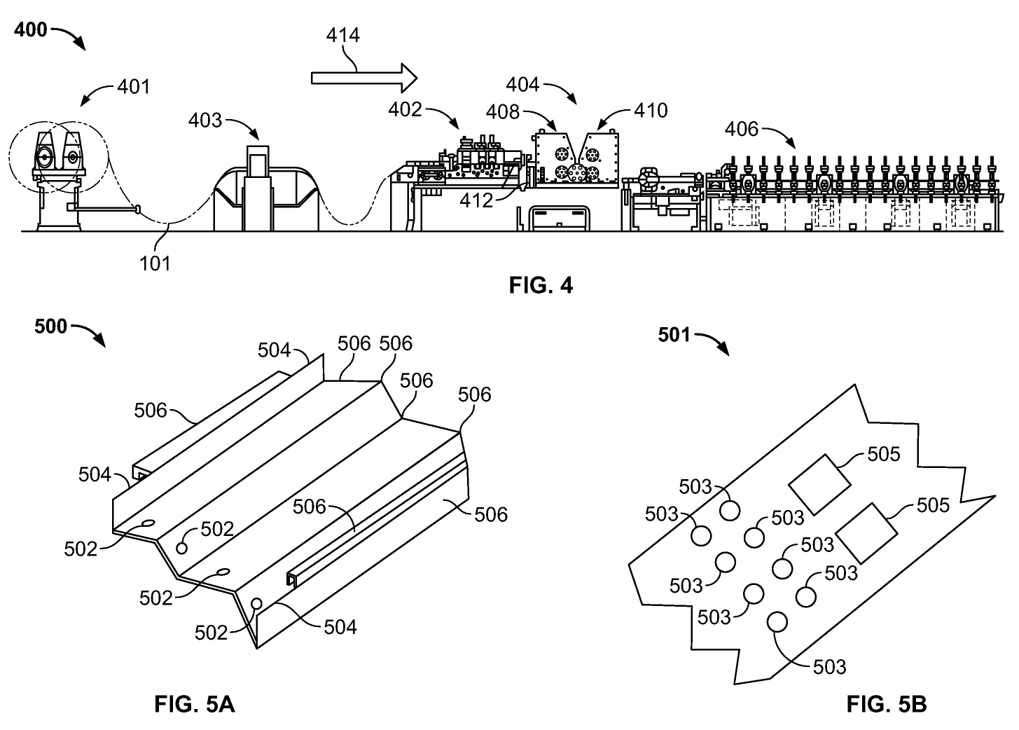

FIG. 4 is an example material forming process 400 that may be configured to use the example rotary press system 102 of FIGS. 1, 2A and 2B. The example material forming process 400 includes a material stock roll 401, a material feed unit 402, a leveler 403, a rotary press system 404, and a roll-former unit 406. The rotary press system 404 may be implemented using the example rotary press system 102 of FIGS. 1, 2A, 2B and 3. In particular, the rotary press system 404 includes a punching rotary press 408 that may be implemented using the example rotary press 105a of FIGS. 1, 2A, 2B and 3, and a shearing rotary press 410 that may be implemented using the example rotary press 105b of FIGS. 1, 2A, 2B and 3. The example material forming process 400 may be used to process a substantially continuously moving material such as, for example, the moving material 101 of FIG. 1.

The example material forming process 400 may be used in combination with other processes that handle or process a material. For example, the example material forming process 400 may be implemented within an assembly line to perform a subset of operations of the assembly line. Alternatively, the example material forming process 400 may be a standalone process that forms a self-contained assembly line performing substantially all of the operations of the assembly line. Although, the example rotary presses 105a and 105b are generally shown in the process configuration of the example material forming process 400, any other configuration using any other process operations in combination with the example rotary presses 105a and 105b may be implemented instead.

As the material 101 moves through the example material forming process 400 along a material translation path 412 in a direction generally indicated by arrow 414, the example material forming process 400 may be configured to alter the shape, form, and/or other aesthetic or physical characteristics of the moving material 101. For example, the example material forming process 400 may be configured to punch, shear, and roll-form the moving material 101 using the punching rotary press 408, the shearing rotary press 410 and the roll-former unit 406 to produce, for example, an example seam panel 500 of FIG. 5A.

The example seam panel 500 is made using a flat sheet (planar) or strip material (i.e., the moving material 101) that is fed by the material feed unit 402 toward the rotary press system 404. The example seam panel portion 500 of FIG. 5A includes a plurality of cutout portions 502, a sheared edge 504, and a plurality of edges 506. Although the example material forming process 400 is configured to produce the example seam panel 500 as described below, the example material forming process 400 may be configured to form other items having other configurations such as, for example, different folds, different cutout portions, different material segment lengths, etc.

In the illustrated example of FIG. 4, the moving material 101 is fed, propelled, or conveyed toward the punching rotary press 408 by the material feed unit 402 along the material translation path 412, and the punching rotary press 408 may be configured to punch the moving material 101 to form two cutout portions 502 of the example seam panel 500. For example, the punching rotary press 408 may be provided with cutting tools such as, for example, a punch that is mechanically coupled to an upper ram (e.g., the upper ram 114a of FIG. 1) and a die that is mechanically coupled to a lower ram (e.g., the lower ram 114b of FIG. 1) that punch cutout portions (e.g., holes) into the moving material 101. The cutout portions 502 of the example seam panel 500 are shown as a plurality of circular holes that are punched in parallel. However, the punching rotary press 408 may be configured to create any other type of cutouts at any position on the moving material 101. In some example implementations, the positions of cutout portions 502 may be set by selecting different punch and die sets. Example punch and die set configurations may include punches and dies that punch cutout portions in various configurations including, for example, a serial configuration, a parallel configuration, a staggered configuration, etc. The material feed unit 402 then feeds, propels, or conveys the moving material 101 toward the shearing rotary press 410.

In the illustrated example, the shearing rotary press 410 is configured to shear (e.g., cut, slice, etc.) the moving material 101 to form the sheared edges 504 to create material sections of any desired length to form a plurality of material segments of the moving material 101 that travel along the material translation path 412 in a serial manner. The shearing rotary press 410 may be configured to shear the moving material 101 by, for example, using a cut-off blade and cut-off ram mechanically coupled to the upper ram 114a (FIGS. 1 and 2B) and the lower ram 114b (FIGS. 1 and 2B), respectively. In the illustrated example, the material segments are moved from the shearing rotary press 410 to the roll-former unit 406.

The roll-former unit 406 includes a plurality roll-forming passes that roll-form the material segments received from the shearing rotary press 410. In the illustrated example, the roll-former unit 406 is configured to obtain the material segments from the shearing rotary press 410 and progressively roll-form each material segment to form the plurality of edges 506 of the example seam panel 500 as the material segments are passed through a series of roll-forming passes. In general, the roll-former unit 406 may be configured to fold the material segments by creating any desired edge or edges using the roll-forming passes. In some example implementations, the material feed unit 402 and the roll-former unit 406 may be configured to move the material 101 at substantially the same speed.

Although the example rotary press systems 102 and 404 are described as having a punching press and a shearing press, in other example implementations, the rotary press systems 102 and 404 may be provided with two punching rotary presses. For example, in the illustrated example of FIG. 4, the rotary press 408 may be configured to punch circular holes and the rotary press 410 that may be configured to punch square holes to produce, for example, an example panel 501 of FIG. 5B. To produce the example panel 501, pre-sheared panels may be fed, propelled or conveyed to the rotary press system 404 and a controller (e.g., the controller 228 of FIG. 2) may be configured to rotate the rams of the first rotary press 408 (and, thus, the rams of the second rotary press 410) at a relatively fast speed relative to the speed of the panel 501 to punch rows of circular holes 503 in the example 501 before the panel 501 reaches the second rotary press 410. The controller 228 can then pause rotation of the presses 408 and 410 as the panel 501 continues to move through the rotary press system 404. When the panel 501 reaches a position at which the square holes 505 are to be punched, the controller 228 can rotate the rams of the second rotary press 410 (and, thus, the rams of the first rotary press 408) to punch the square holes 505.

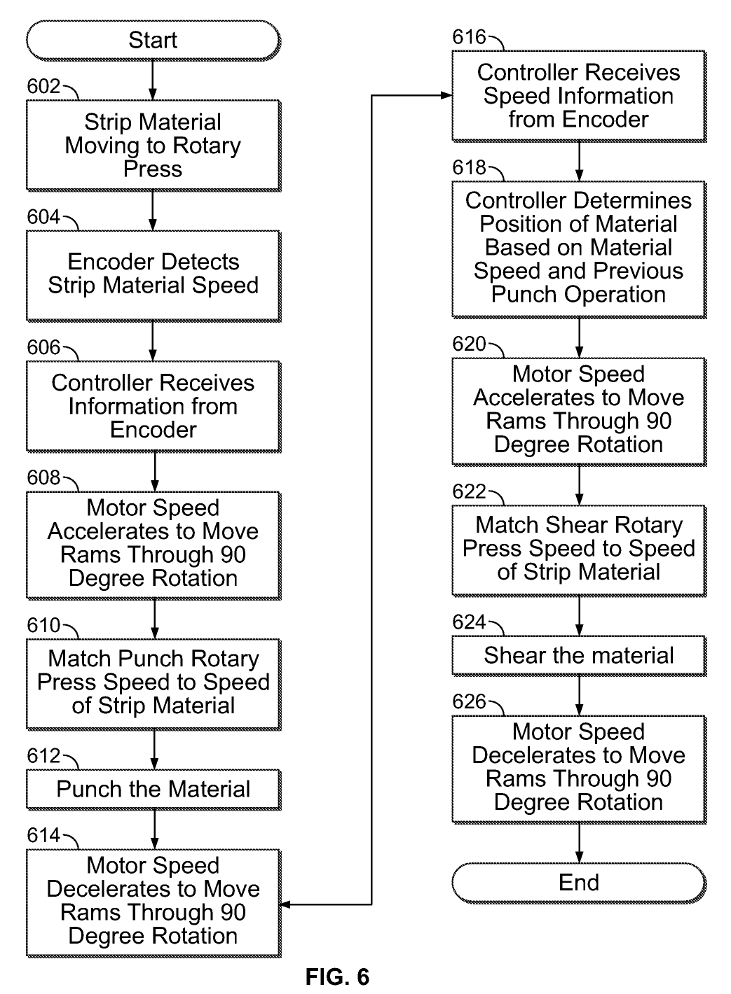

FIG. 6 is a flow chart of an example method that may be used to implement the rotary press system 102 of FIGS. 1, 2A, 2B and 3. In some example implementations, the example method of FIG. 6 may be implemented using machine readable instructions comprising a program for execution by a processor (e.g., the processor 712 shown in the example system 710 of FIG. 7) such as, for example, a processor of the controller 228 (FIG. 2B). The program may be embodied in software stored on a tangible medium such as a CD-ROM, a floppy disk, a hard drive, a digital versatile disk (DVD), or memory associated with the processor 712 and/or embodied in firmware and/or dedicated hardware in a well-known manner. Further, although the example program is described with reference to the flow chart illustrated in FIG. 6, persons of ordinary skill in the art will readily appreciate that many other methods of implementing the example rotary press system 102 may alternatively be used. For example, the order of execution of the blocks may be changed, and/or some of the blocks described may be changed, eliminated, or combined.

Turning in detail to FIG. 6, as the material 101 moves to the rotary press system 102 (block 602), the encoder 232 (FIG. 2) detects the speed of the material 101 (block 604). The controller 228 then receives the speed information from the encoder 232 (block 606) and causes the speed of the motor 200 to accelerate to move the rams 114a and 114b and the rams 214a and 214b through a 90 degree phase (block 608) of their respective generally circular or elliptical paths. For example, as shown in FIG. 3, the controller 228 causes the motor 200 to accelerate to move the rams 114a and 114b 90 degrees from a position shown in the phase position T₀ 304 to a cutting position shown in the phase T₁ 306. By accelerating the motor 200, the controller 228 causes the rams 114a and 114b to match the speed of the material 101 (block 610) as the rams 114a and 114b approach the cutting position. The rams 114a and 114b then punch the material 101 (block 612) while the material 101 continues to move. As shown in FIG. 3, the rams 114a and 114b move toward their cutting position, while the rams 214a and 214b move away from their cutting position

After the rotary press 105a punches the material 101, the rams 114a and 114b continue to move through and away from the cutting position of the T₁ phase 306 (FIG. 3), and the controller 228 causes the motor 200 to decelerate (block 614). As the motor decelerates at block 614, the rams 114a and 114b of the punching rotary press 105a and the rams 214a and 214b of the shearing rotary press 105b synchronously decelerate through a subsequent 90 degrees to their respective positions of the T₂ phase 308.

As the material 101 continues to move through the rotary press system 102, the controller 228 receives material speed information from the encoder 232 (block 616). The controller 228 then determines the position of the material 101 based on the speed information and a recorded time of the punch operation performed at block 612 (block 618). In some example implementations, the controller 228 may be configured to cause the motor 200 to pause after the motor 200 decelerates as the rams 114a and 114b continue to move away from the cutting position of the T₁ phase 306 (FIG. 3) and before the rams 214a and 214b accelerate to move toward the cutting position shown in the T₃ phase position 310 (FIG. 3). The pause in motor rotation allows the material 101 to continue to move through the press system 102 after the punching operation and prior to the shearing operation discussed below. This pause in rotation causes the material 101 to continue to move through the press system prior to the shearing operation, thereby resulting in a longer product.

To shear the material 101 at a shearing position, the controller 228 causes the motor 200 to accelerate to cause the rams 114a and 114b and the rams 214a and 214b to accelerate through a 90 degree phase (block 620) of their respective generally circular or elliptical paths. As the motor 200 accelerates through a 90 degree phase, the rams 214a and 214b move from the T₂ phase position 308 toward a cutting position shown in the T₃ phase position 310. In addition, the rams 114a and 114b of the rotary press 105a substantially simultaneously move further away from their cutting position to a maximum open position shown in the T₃ phase 310.

As the rams 214a and 214b of the shearing press 105b reach their cutting position, the controller 228 causes the speed of the rams 214a and 214b to match the speed of the material 101 (block 622), and the shearing rams 214a and 214b shear the material 101 (block 624). The controller 228 then causes the rams 114a, 114b, 214a and 214b to decelerate as they move to their subsequent positions (block 626) shown in the T₀ phase 304 of FIG. 3. The rotary press system 102 can then continue to punch and shear subsequent material as described above or the example process of FIG. 6 can end. As discussed above, in some example implementations, the controller 228 may configured to cause the motor 200 to pause after the motor 200 decelerates while the rams 214a and 214b move away from the cutting position of the T₃ phase 310 (FIG. 3).

In the example process described above, the controller 228 causes the rams 114a, 114b, 214a and 214b to accelerate and decelerate through 90 degree phases. However, in other example implementations, the controller 228 can cause the rams 114a, 114b, 214a and 214b to accelerate and decelerate through different angular rotations such as, for example, a 45 degree rotation, a 180 degree rotation, etc. For example, the controller 228 may cause the rams 114a, 114b, 214a and 214b to accelerate through a 45 degree rotation to match the speed of the material 101 and then to travel at the speed of the material 101 through the next 45 degrees until the rams 114a, 114b, 214a and 214b strike the material 101. In yet other example implementations, the controller 228 may be configured to cause the motor 200 to accelerate, decelerate, and/or pause using different patterns to achieve different punching and/or shearing configurations.

FIG. 7 is a block diagram of an example processor system 710 that may be used to implement the methods and systems described herein. As shown in FIG. 7, the processor system 710 includes a processor 712 that is coupled to an interconnection bus 714. The processor 712 includes a register set or register space 716, which is depicted in FIG. 7 as being entirely on-chip, but which could alternatively be located entirely or partially off-chip and directly coupled to the processor 712 via dedicated electrical connections and/or via the interconnection bus 714. The processor 712 may be any suitable processor, processing unit or microprocessor. Although not shown in FIG. 7, the system 710 may be a multi-processor system and, thus, may include one or more additional processors that are identical or similar to the processor 712 and that are communicatively coupled to the interconnection bus 714.

The processor 712 of FIG. 7 is coupled to a chipset 718, which includes a memory controller 720 and an input/output (I/O) controller 722. As is well known, a chipset typically provides I/O and memory management functions as well as a plurality of general purpose and/or special purpose registers, timers, etc. that are accessible or used by one or more processors coupled to the chipset 718. The memory controller 720 performs functions that enable the processor 712 (or processors if there are multiple processors) to access a system memory 724 and a mass storage memory 725.

The system memory 724 may include any desired type of volatile and/or non-volatile memory such as, for example, static random access memory (SRAM), dynamic random access memory (DRAM), flash memory, read-only memory (ROM), etc. The mass storage memory 725 may include any desired type of mass storage device including hard disk drives, optical drives, tape storage devices, etc.

The I/O controller 722 performs functions that enable the processor 712 to communicate with peripheral input/output (I/O) devices 726 and 728 and a network interface 730 via an I/O bus 732. The I/O devices 726 and 728 may be any desired type of I/O device such as, for example, a keyboard, a video display or monitor, a mouse, etc. The network interface 730 may be, for example, an Ethernet device, an asynchronous transfer mode (ATM) device, an 802.11 device, a DSL modem, a cable modem, a cellular modem, etc. that enables the processor system 710 to communicate with another processor system.

While the memory controller 720 and the I/O controller 722 are depicted in FIG. 7 as separate functional blocks within the chipset 718, the functions performed by these blocks may be integrated within a single semiconductor circuit or may be implemented using two or more separate integrated circuits.

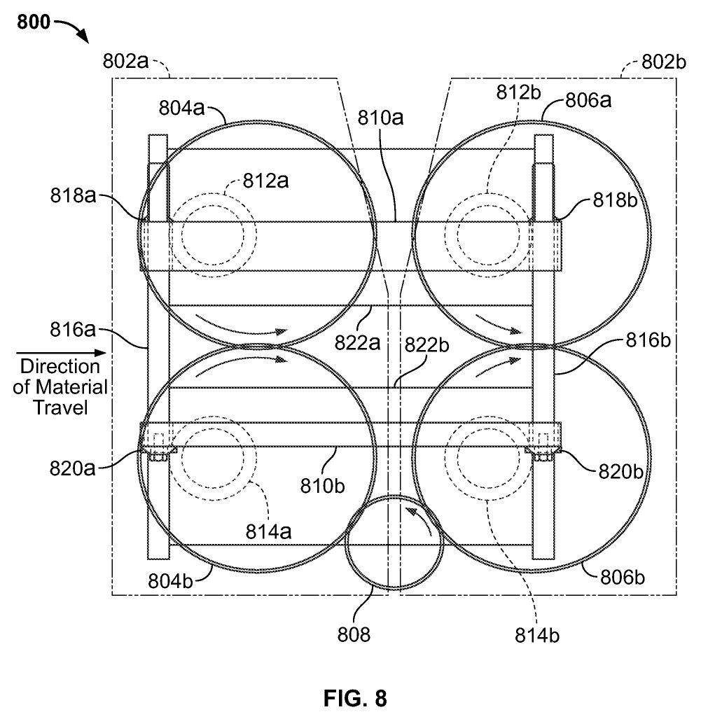

FIG. 8 illustrates another example rotary press system 800 that may be used to form patterns covering relatively large areas in strip material such as, for example, the strip material 101. The example rotary press system 800 includes a first rotary press 802a adjacent a second rotary press 802b. Those components of the rotary press system 800 that are substantially similar or identical to the components of the rotary press system 102 described above and that have functions substantially similar or identical to the functions of those components will not be described in detail again below. Instead, the interested reader is referred to the above corresponding descriptions. For example, the first rotary press 802a includes upper and lower spur gears 804a and 804b, which are substantially similar or identical to spur gears 110a and 110b of the first rotary press 105a (FIG. 1). In addition, the second rotary press 802b includes upper and lower spur gears 806a and 806b that are substantially similar or identical to the spur gears 210a and 210b of the second rotary press 105b (FIG. 1). Furthermore, a common drive gear 808 used to drive the lower spur gears 804b and 806b is substantially similar or identical to the common drive gear 112 of the rotary press system 102 (FIG. 1). Additionally, although not shown, the rotary press system 800 includes components substantially similar or identical to the components 110c, 110d, 210c, 210d, 212, 218, 224, 232, 228, and 200 of the rotary press system 102.

The example rotary press system 800 includes a first punching means or upper ram 810a and a second punching means or lower ram 810b. The upper ram 810a is rotatably coupled to the upper spur gears 804a and 806a via hubs or crank pins 812a and 812b, and the lower ram 810b is rotatably coupled to the lower spur gears 804b and 806b via hubs or crank pins 814a and 814b. Linear guides 816a and 816b interconnect the upper and lower rams 810a and 810b. The linear guides 816a and 816b are slidably coupled to the upper ram 810a via linear bearings 818a-b and are coupled or fixed to the lower ram 810b via couplings 820a-b. The linear guides 816a and 816b ensure that the upper ram 810a and the lower ram 810b remain in alignment with each other so that a pressing face 822a of the upper ram 810a and a pressing face 822b of the lower ram 810b remain substantially parallel to one another as the upper spur gears 804a and 806a and lower spur gears 804b and 806b rotate about their respective rotational axes. The linear bearings 818a-b may be implemented using any type of bearing that enables linear translation of the rams 810a-b along the linear guides 816a and 816b.

The rams 810a and 810b may be mechanically coupled to material penetration or cutting devices (i.e., cutting tool members) such as, for example, conventional cutting tools (i.e., punch and die sets, cut-off blade and cut-off ram sets) or any other suitable types of cutting tools. Additionally, the rams 810a and 810b are configured to provide sufficient structural strength to maintain their structural integrity while impacting (e.g., cutting) a material such as, for example, the material 101, as it moves (e.g., continuously) through the rotary presses 802a and 802b.

Similar to the rotary press system 102, the example rotary press system 800 is driven via the common drive gear 808. In the illustrated example, the common drive gear 808 is shown as directly engaging the lower spur gear 804b of the first rotary press 802a and the lower spur gear 806b of the second rotary press 802b to form a direct drive configuration. In turn, the upper spur gears 804a and 806a directly engage respective ones of the lower spur gears 804b and 806b. In this configuration, the common drive gear 808 may directly drive the spur gears 804a, 804b, 806a, and 806b to cause the spur gears 804a, 804b, 806a, and 806b to rotate about their respective rotational axes to enable the rams 810a and 810b to work cooperatively to punch, notch, cut, or otherwise penetrate a material as it moves through the rotary press system 800. To rotate the common drive gear 808, the example rotary press system 800 is provided with a rotary actuation member, which is implemented using a drive motor such as, for example, the drive motor 200 of FIG. 2B. In some example implementations, the drive motor can be coupled directly to the common drive gear 808 in a direct-drive configuration with or without an intervening gear box.

In the illustrated example, the rotation of the upper spur gears 804a and 806a causes the upper ram 810a to move along a respective generally circular path and rotation of the lower spur gears 804b and 806b causes the lower ram 810b to move along a respective generally circular path. In particular, the common drive gear 808 causes the lower spur gears 804b and 806b to rotate in a first direction (e.g., a clockwise direction). In turn, the lower spur gears 804b and 806b cause the upper spur gears 804a and 806a to rotate in a second direction (e.g., a counter-clockwise direction) opposite the first direction (e.g., a clockwise direction) of the lower spur gears 804b and 806b.

In contrast to the rotary press system 102 of FIG. 1, the example rotary presses 802a and 802b operate in phase relative to each other. In other words, the crank pin 812a is at the same rotational phase position as the crank pin 812b and the crank pin 814a is at the same rotational phase position as the crank pin 814b. That is, the crank pins 812a and 812b are in phase relative to each other and travel simultaneously along the same rotational phase positions while the crank pins 814a and 814b are in phase relative to each other and travel simultaneously along the same rotational phase positions. In this manner, the counter-rotation of the upper spur gears 804a and 806a relative to the lower spur gears 804b and 806b causes the upper and lower rams 810a and 810b to synchronously rotate such that the pressing faces 822a and 822b are substantially parallel and aligned relative to each other as the gears 804a-b and 806a-b rotate to drive the rams 810a and 810b to a pressing position, in which the rams 810a and 810b are located at a position on their respective generally circular paths so that the distance between the cutting tool members of the rams 810a and 810b is at a minimum. When approaching and rotating through the pressing position, the rotational speed of the gears 804a, 806a, 804b, and 806b can be controlled so that the speed of the rams 810a and 810b (and the cutting tool members) match the translational speed of the surfaces of the material as it moves through the rotary presses 802a and 802b. In this manner, the speed and horizontal translation components of the rams 810a and 810b enable the cutting tool members to punch, cut, nip, penetrate, or otherwise process the material without interrupting the continuous movement of the material through the rotary press system 800.

As the pressing faces 822a and 822b travel in opposing directions along respective generally circular paths, the cutting tool members (not shown) work cooperatively to punch, or otherwise cut or penetrate the material (e.g., the material 101) as it moves through the rotary press system 800. As described above, a cutting tool member (not shown) may be mechanically coupled to the pressing face 822a and a complementary cutting tool member (not shown) may be mechanically coupled to the pressing face 822b. As the pressing faces 822a and 822b travel along their respective generally circular paths, the faces of the cutting tool members are held substantially parallel and/or aligned relative to each other.

Although not shown in FIG. 8, the rotary presses 802a and 802b have other end sides that include upper and lower spur gears that are substantially similar or identical to respective ones of the gears 804a, 804b, 806a, 806b, and 808. The gears 804a, 804b, 806a, 806b, and 808, and their respective gears on the other end side of the example rotary press system 800 shown in FIG. 8, may be implemented using any type of gears or other drive members having any suitable shape and that enable rotation about respective rotational axes.

A driving means for commonly driving the rams 810a and 810b includes a shaft (similar or identical to the shaft 218 shown in FIG. 2B) having the common drive gear 808 coupled to a proximate shaft end proximate a drive motor (e.g., the motor 200 of FIG. 2B) and a second common drive gear (similar or identical to the second common gear 212 of FIG. 2B) coupled to a distal shaft end. In this manner, the motor 200 can rotate the shaft (not shown) to transfer rotational power to the common drive gear 808 engaging the rotary members 804b and 806b and the other common drive gear (not shown) at the distal end of the shaft and engaging distal end rotary members corresponding to the rotary members 804b and 806b. In turn, the lower rotary members on the other end of the presses 802a and 802b that correspond to the lower rotary members 804b and 806b engage upper rotary members corresponding to the upper rotary members 804a and 806a.

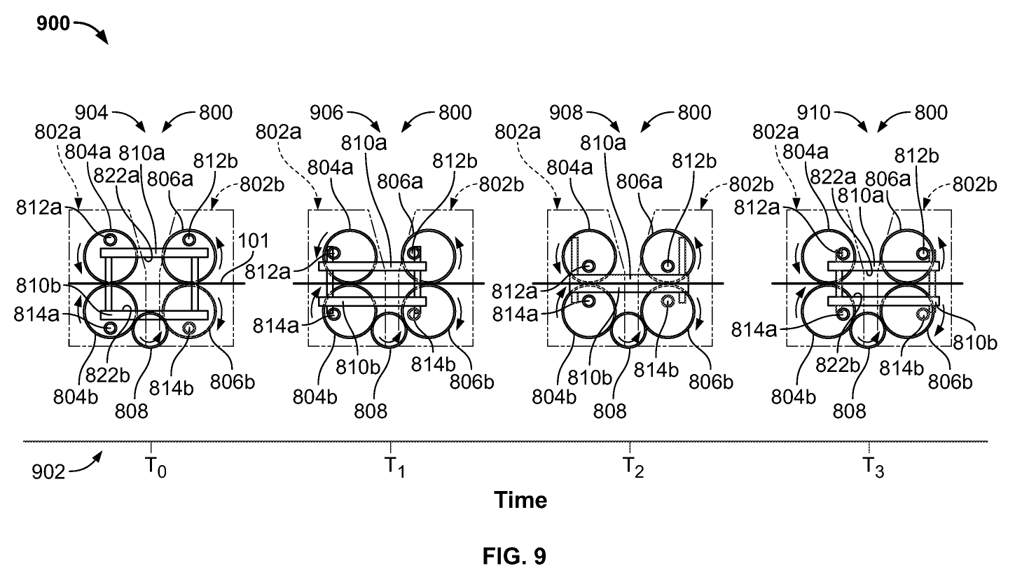

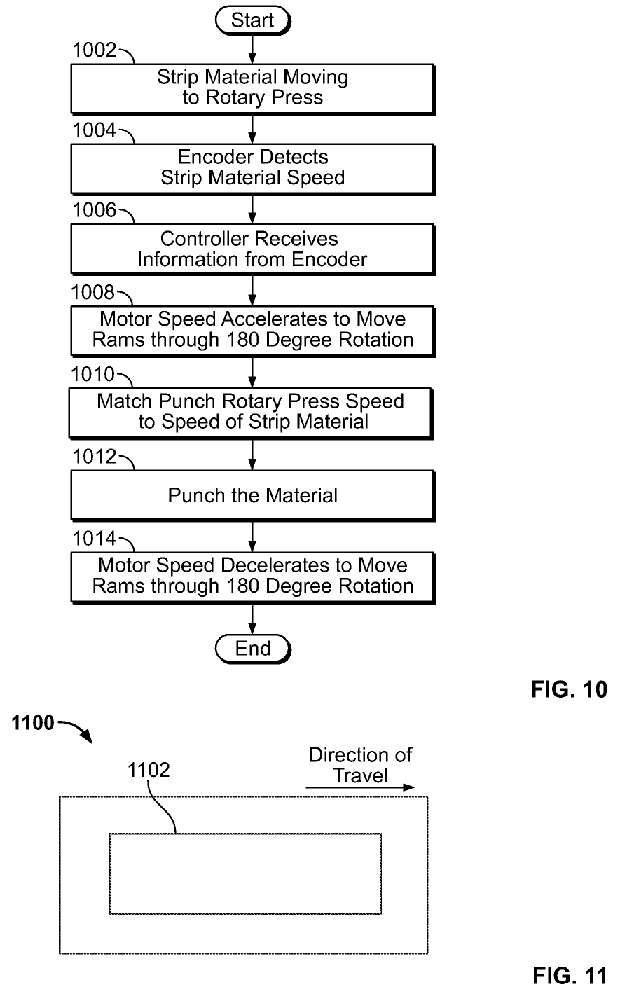

FIG. 9 is an example time sequence view 900 showing the operation of the example rotary press system 800 of FIG. 8. In particular, the example time sequence 900 shows the time-varying relationship between the common drive gear 808, the spur gears 804a, 804b, 806a, and 806b, and the rams 810a and 810b during operation of the rotary press system 800 of FIG. 8. As shown in FIG. 9, the example time sequence 900 includes a time line 902 and shows the rotary presses 802a and 802b at several times during operation. More specifically, the rotary presses 802a and 802b are shown in a sequence of rotary press phase positions indicated by a T₀ phase position 904, a T₁ phase position 906, a T₂ phase position 908, and a T₃ phase position 910. As the upper spur gears 804a and 806a rotate in a counter-clockwise direction and the lower spur gears 804b and 806b rotate in a clockwise direction, the operation of the rotary presses 802a and 802b progresses through the phases 904, 906, 908, and 910. Although FIG. 9 depicts only a first gear assembly side of the rotary press system 800, a second side of the rotary press system 800 works cooperatively with the first side shown to enable operation of the rotary presses 802a and 802b according to the example operational sequence shown in FIG. 9.

Now turning in detail to the operation of the rotary presses 802a and 802b, a drive motor (e.g., the drive motor 200 of FIG. 2A) drives the common drive gear 808 in a counter-clockwise direction. The common drive gear 808, in turn, causes the lower spur gears 804b and 806b to rotate in a clockwise direction, and each of the gears 804b and 806b causes a respective one of the upper spur gears 804a and 806a to rotate in a counter-clockwise direction. As the spur gears 804a and 804b and 806a and 806b rotate, the rams 810a and 810b travel along their respective generally circular or elliptical paths as shown by the phase positions 904, 906, 908, and 910. Also, the rams 810a and 810b are held in substantially vertical alignment relative to each other as they travel along their respective paths.

In the illustrated example, the rotary press system 800 completes a cycle with a 360-degree rotation of the upper and lower spur gears 804a-b and 806a-b. The T₀ phase position 904 shows the rams 810a and 810b at their initial position or a maximum open position (e.g., the rams 810a and 810b are the furthest away from one another along their respective circular or elliptical paths). The T₁ phase position 906 shows the rams 810a and 810b as they travel toward the cutting position.

The example rotary presses 802a and 802b are in phase relative to each other. The crank pins 812a and 812b are at the same phase or angular position relative to each other and travel simultaneously along the same rotational phase positions, while the crank pins 814a and 814b are at the same phase or angular position and travel simultaneously along the same rotational phase positions. As described in greater detail below, the rams 810a and 810b can accelerate or decelerate to match the speed of the material 101 traveling through the press system 800 as the rams 810a and 810b approach the cutting position shown in the T₂ phase position 908. The T₂ phase position 908 shows the rams 810a and 810b as they travel through the cutting position (e.g., a pressing position, a nip position, a shearing position, a punching position, etc.). As the rams 810a and 810b meet to punch, cut, etc. the material 101, the rams 810a and 810b match the speed of the material 101 at the pressing position shown in the T₂ phase position 908. At the pressing position, the material 101 is punched to remove a portion of the material 101 as it moves through the rotary presses 802a and 802b.

The T₃ phase position 910 shows the rams 810a and 810b of the rotary press system 800 as they travel away from the cutting position shown in the T₂ phase position. In the illustrated example, the press system completes a 360-degree cycle as the position of the rams 810a and 810b return to the T₀ phase position 904.

The example rotary press 800 is implemented using a drive system and a control system similar to the drive and control systems described in connection with the rotary press system 102. For example, the example rotary press system 800 may be implemented using machine readable instructions comprising a program for execution by a processor (e.g., the processor 712 shown in the example system 710 of FIG. 7) such as, for example, a processor of a controller (e.g., the controller 228 of FIG. 2B). The program may be embodied in software stored on a tangible medium such as a CD-ROM, a floppy disk, a hard drive, a digital versatile disk (DVD), or memory associated with a processor (e.g., the processer 712 of FIG. 7) and/or embodied in firmware and/or dedicated hardware in a well-known manner.

For example, as a material (e.g., the material 101) moves toward the rotary press system 800 (block 1002), an encoder (e.g., the encoder 232 of FIG. 2B) detects the speed of the material 101 (block 1004). A controller (e.g., the controller 228 of FIG. 2B) receives the speed information from the encoder 232 (block 1006) and causes the speed of a motor (e.g., the motor 200 of FIG. 2B) to accelerate to move the rams 810a and 810b through a 180-degree phase rotation (block 1008) of their respective generally circular paths. For example, the controller 228 causes the motor 200 to accelerate to move the rams 810a and 810b through a 180-degree phase rotation from a position shown in the T₀ phase position 904 (FIG. 9) to the pressing position shown in the T₂ phase position 908 (block 1008). By accelerating the motor 200, the controller 228 causes the speed of the rams 810a and 810b to match the speed of the material 101 (block 1010) as the rams 810a and 810b approach the pressing position. The rams 810a and 810b then punch the material 101 (block 1012) while the material 101 continues to move. The rams 810a and 810b continue to move through and away from the cutting position of the T₃ phase position 910. The controller 228 causes the motor to decelerate as the rams 810a and 810b move through another 180-degree phase from the pressing position in the T₂ phase position 908 to a non-pressing position in the T₀ phase position 904 (block 1014). The rotary press system 800 can continue to process subsequent material as described above or the example process can end. In some example implementations, the controller 228 may be configured to cause the motor 200 to pause after the motor 200 decelerates while the rams 810a and 810b move away from the pressing position to control the distance between punches formed in the material 101.

In the example process described above, the controller 228 can cause the rams 810a and 810b to accelerate and decelerate through different angular rotations such as, for example, a 45-degree rotation, a 180-degree rotation, etc. For example, the controller 228 may cause the rams 810a and 810b to accelerate through a 45-degree rotation to match the speed of the material 101 and then to travel at the speed of the material 101 through the next 45-degrees until the rams 810a and 810b strike the material 101.

In yet other example implementations, the controller 228 may be configured to cause the motor 200 to accelerate, decelerate, and/or pause between each pressing cycle to achieve different processing requirements or processing patterns. To achieve cutting patterns having, for example, punched holes that are relatively close to one another, the controller 228 may be configured to cause the rams 810a and 810b to accelerate after the rams 810a and 810b leave the pressing position so that the speed of the rams 810a and 810b is greater than the speed of the material 101. As the rams 810a and 810b approach the pressing position, the controller 228 causes the rams 810a and 810b to decelerate so that the rams 810a and 810b match the translational speed of the material 101.

The example press system 800 can be advantageously used to form relatively larger punch patterns in a material than, for example, the rotary press system 102 described above. For example, FIG. 11 illustrates an example material 1100 processed by the example press system 800. The example processed material 900 includes a substantially large cutout portion 1102. In other examples, the rotary press 800 may be configured to form other patterns having other configurations such as, for example, multiple cutout portions, differently shaped cutout portions, etc.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

1. A rotary press system, comprising:
a first rotary press;
a second rotary press adjacent the first rotary press, wherein the first and second rotary presses are to receive a strip material;
a drive member operatively coupled to the first and second rotary presses; and
a motor coupled to the drive member to rotate the drive member and to cause the first and second rotary presses to process the strip material.

2. A system as defined in claim 1, further comprising a controller operatively coupled to the motor to cause the motor to rotate through a first phase and a second phase, wherein the rotation of the motor through the first and the second phases causes the first and second rotary presses to process the strip material.

3. A system as defined in claim 2, wherein the controller is to cause the drive member to accelerate during a first portion of the first phase and decelerate during a second portion of the first phase and to cause the drive member to accelerate during a first portion of the second phase and decelerate during a second portion of the second phase.

4. A system as defined in claim 2, wherein the controller is to cause the motor to pause rotation of the drive member between the first and the second phases.

5. A system as defined in claim 1, wherein the motor is to cause the first and the second rotary presses to process the strip material while the strip material substantially continuously moves through the first and second rotary presses.

6. A system as defined in claim 1, wherein the drive member is a gear.

7. A system as defined in claim 1, wherein the motor is directly coupled to the drive member via a gear.

8. A system as defined in claim 1, wherein the drive member is to cause the first and second rotary presses to operate simultaneously.

9. A system as defined in claim 1, wherein the first rotary press is to process the material by punching the strip material and the second rotary press is to process the material by shearing the strip material.

10. A system as defined in claim 1, wherein the first rotary press includes a first rotary member and a second rotary member and the second rotary press includes a third rotary member and a fourth rotary member, further comprising an upper ram rotatably coupled to the first rotary member and the third rotary member and a lower ram rotatably coupled to the second rotary member and the fourth rotary member.

11. A system as defined in claim 10, further comprising a guide fixed to the upper ram and slidably coupled to the lower ram to maintain a pressing face of the upper ram substantially parallel to a pressing face of the lower ram.

12. A method of processing a moving material, the method comprising:
moving a material through a first rotary press and a second rotary press spaced from the first rotary press; and
driving the first and second rotary presses via a drive member operatively coupled to the first and second rotary presses to cause the first rotary press to contact the material at a first position during a first time interval, and the second rotary press to contact the material at a second position during a second time interval.

13. A method as defined in claim 12, wherein moving the material through the first and second rotary presses comprises substantially continuously moving the material.

14. A method as defined in claim 12, wherein the material is a strip material.

15. A method as defined in claim 12, the method further comprising synchronously driving the first and second rotary presses.

16. A method as defined in claim 12, the method further comprising pausing the first and second rotary presses between the first and the second time intervals.

17. A method as defined in claim 12, wherein the drive member accelerates during a first portion of the first time interval and decelerates during a second portion of the first time interval and accelerates during a first portion of the second time interval and decelerates during a second portion of the second time interval.

18. A method as defined in claim 12, wherein the drive member is a gear engaged to the first and second rotary presses.

19. A rotary press system comprising:
first means for punching or shearing a strip material;
second means for punching or shearing the strip material;
driving means for driving the first and second means for punching or shearing the strip material, wherein the driving means engages a first rotary member of the first means for punching or shearing the strip material and a second rotary member of the second means for punching or shearing the strip material; and
means for controlling the driving means to cause the first and the second means for punching or shearing the strip material to operate synchronously.

20. A rotary press system defined in claim 19, wherein the means for controlling is to pause the driving means between a first time interval during which the first means punches or shears the strip material and a second time interval during which the second means punches or shears the strip material.

21. A rotary press system defined in claim 20, wherein the means for controlling is to accelerate the driving means during a first portion of the first time interval and decelerate the driving means during a second portion of the first time interval.

22. A rotary press system defined in claim 20, wherein the means for controlling the driving means is to cause the first and the second means for punching or shearing the strip material to operate simultaneously during the first and second time interval.

23. A rotary press system defined in claim 20, wherein the means for controlling the driving means is to cause the first means for punching or shearing the strip material to contact the material at a first position during the first time interval and the second means for punching or shearing the strip material to contact the material at a second position during a second time interval.

24. A method of processing a moving material, the method comprising:
moving a material through a first rotary press having a first lower rotary member and a first upper rotary member and a second rotary press having a second lower rotary member and a second upper rotary member, wherein a lower ram is rotatably coupled to the first lower rotary member of the first press and the second lower rotary member of the second press, and wherein an upper ram is rotatably coupled to the first upper rotary member of the first press and the second upper rotary member of the second press; and
driving the first and second rotary presses via a common drive member engaging the first and second rotary members of the first and second rotary presses.

25. A method as defined in claim 24, wherein moving the material through the first and second rotary presses comprises moving the material while punching the material via the upper and lower rams.

26. A method as defined in claim 24, wherein the material is a strip material.

27. A method as defined in claim 24, further comprising accelerating the drive member prior to punching the material via the upper and lower rams and decelerating the drive member after punching the material.

28. A rotary press system comprising:
first and second punching means for punching a strip material, wherein the first punching means is rotatably coupled between first and second upper rotary members that rotate about a first rotational axis and rotatably coupled between third and fourth upper rotary members that rotate about a second rotational axis, and wherein the second punching means is rotatably coupled between first and second lower rotary members that rotate about a third rotational axis and rotatably coupled between third and fourth lower rotary members that rotate about a fourth rotational axis;
driving means for commonly driving the first and second means for punching the strip material, wherein the driving means engages the first, second, third, and fourth rotary members; and
controlling means for controlling the driving means to cause the first and second punching means to punch the strip material.

29. A rotary press system defined in claim 28, wherein the controlling means is to accelerate the driving means before punching the material via the first and second punching means and decelerate the driving means after punching the material.

30. A rotary press system defined in claim 28, wherein the controlling means is to decelerate the driving means before punching the material via the first and second punching means and accelerate the driving means after punching the material.
